(19) United States
(12) Patent Application Publication
(10) Pub. No.: US 2011/0101184 A1
(43) Pub. Date: May 5, 2011

(54) STRUCTURE FOR ATTACHING AN OBJECT TO A MAST

(75) Inventors: Morgan Kirby, Palmer Lake, CO (US); Jason Fruh, Lone Tree, CO (US)

(73) Assignee: ECHOSTAR TECHNOLOGIES L.L.C., Englewood, CO (US)

(21) Appl. No.: 12/611,767

(22) Filed: Nov. 3, 2009

(51) Int. Cl. F16M 13/00; H01Q 1/12

(52) U.S. Cl. 248/218.4; 343/890

(57) ABSTRACT

An apparatus for mounting an object to a mast is presented. The apparatus includes a mast-end component configured to be attached to the mast, and an object-end component configured to be attached to the object. Each of the components has a pivot region which includes a set of extensions, with each extension defining at least one opening. The extensions of the object-end component mesh with the extensions of the mast-end component, with the openings of the extensions aligning along an axis. The apparatus further includes a fastener extending through the openings of the extensions along the axis. When the fastener is tightened, the first and second extensions are compressed together to maintain an angular orientation between the mast-end component and the object-end component about the axis.

### BACKGROUND

With the introduction of direct-to-home satellite broadcast television systems, such as Direct Broadcast Satellite (DBS) systems, a multitude of television programs, audio channels, and the like previously unknown with terrestrial (“over-the-air”) broadcast systems was made accessible to millions of potential subscribers. One aspect of such systems that allows such wide accessibility is the use of a small (e.g., less than one meter in diameter) and inexpensive satellite antenna, or “dish”. To effectively employ such an antenna, a subscriber merely provides direct line-of-sight between the dish and the satellites of interest, and supplies a stable mounting structure or base to which the antenna is mounted, such as the exterior of the subscriber's home. The latter requirement helps prevent the antenna from becoming misaligned or misdirected as the result of strong winds or other meteorological conditions, which may cause disruption of the satellite signal carrying the programming.

To couple the antenna to a stable mounting structure, and to allow adjustment of the orientation of the dish to align with a transmitting satellite in geosynchronous orbit, the antenna is often coupled with an antenna “mast” or pole having an end connected to the mounting structure, with the antenna being attached near the end of the mast opposite the structure. More specifically, the mast is often attached to a footing that is securely affixed to the structure, with the connection between the mast and footing allowing the mast to pivot in a vertical plane to allow the subscriber or installer to align the end of the mast that is to be coupled to the antenna in a vertical direction. Given this mast orientation, the connection of the antenna with the mast typically facilitates adjustment of both the elevation (i.e., the up-and-down orientation) and azimuth (i.e., the side-to-side orientation) of the antenna. This connection normally constitutes a somewhat substantial hardware subassembly including a number of components, along with several bolts and/or other fasteners, that allow the subscriber or installer to firmly hold the antenna in place once the proper antenna orientation has been determined. Further, the antenna/mast connection often includes an antenna bracket that is directly connected to the antenna and that provides a mechanism to alter the skew (i.e., the rotational side-to-side tilt) of the antenna. Oftentimes, markings on the antenna/mast subassembly allow the installer to set an initial known elevation, azimuth, and skew for the antenna prior to fine-tuning the antenna orientation based on the strength of the signal received from the satellite of interest.

The connection of the antenna with the mast typically allows enough rotation of the antenna about the mast to adjust the elevation and azimuth of the antenna sufficiently. To this end, the mast is often 18 inches or more in length to allow the antenna to be positioned at a sufficient distance from the mounting structure to allow such adjustments to be undertaken without the antenna contacting the mounting structure. A mast of such a length, however, may also create a significant mechanical load or torque on the mounting structure, especially in the presence of winds and other environmental forces that may act upon the antenna. To address such concerns, as well as to allow the use of relatively large antennas, a strut may also be coupled between the mast and the footing or mounting structure to strengthen the overall assembly.

### BRIEF DESCRIPTION OF THE DRAWINGS

Many aspects of the present disclosure may be better understood with reference to the following drawings. The components in the drawings are not necessarily depicted to scale, as emphasis is instead placed upon clear illustration of the principles of the disclosure. Moreover, in the drawings, like reference numerals designate corresponding parts throughout the several views. Also, while several embodiments are described in connection with these drawings, the disclosure is not limited to the embodiments disclosed herein. On the contrary, the intent is to cover all alternatives, modifications, and equivalents.

FIGS. 1A and 1B are perspective and side views, respectively, of an apparatus for attaching an object to a mast according to an embodiment of the invention.

FIGS. 2A and 2B are perspective and side views, respectively, of a subassembly of a mast and a satellite antenna bracket connected together with the apparatus of FIGS. 1A and 1B according to an embodiment of the invention.

FIGS. 3A and 3B are perspective and side views, respectively, of an apparatus for connecting two masts together according to an embodiment of the invention.

FIGS. 4A and 4B are perspective and side views, respectively, of an assembly of two masts coupled together using the apparatus of FIGS. 3A and 3B according to an embodiment of the invention.

FIG. 5 is a flow diagram of a method according to an embodiment of the invention of attaching an object to a mast.

### DETAILED DESCRIPTION

The enclosed drawings and the following description depict specific embodiments of the invention to teach those skilled in the art how to make and use the best mode of the invention. For the purpose of teaching inventive principles, some conventional aspects have been simplified or omitted. Those skilled in the art will appreciate variations of these embodiments that fall within the scope of the invention. Those skilled in the art will also appreciate that the features described below can be combined in various ways to form multiple embodiments of the invention. As a result, the invention is not limited to the specific embodiments described below, but only by the claims and their equivalents.

In addition, directional references employed below, such as “up”, “down”, “left”, “right”, “back”, “front”, “upper”, “lower”, “vertical”, “horizontal”, and so on, are provided to relate various aspects of the structures to each other, and are not intended to limit the embodiments disclosed herein to a particular orientation with respect to their surrounding environment.

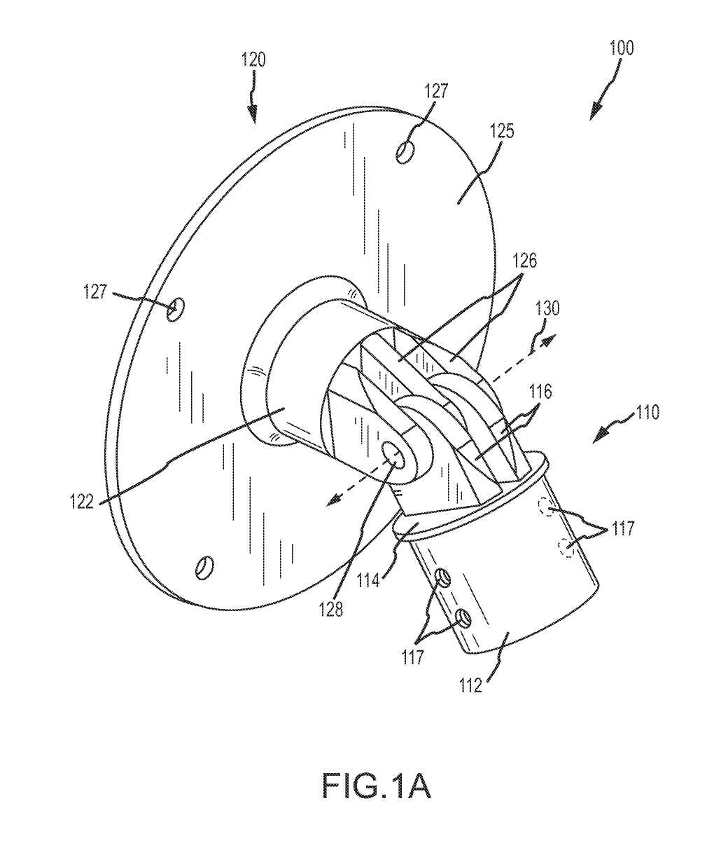

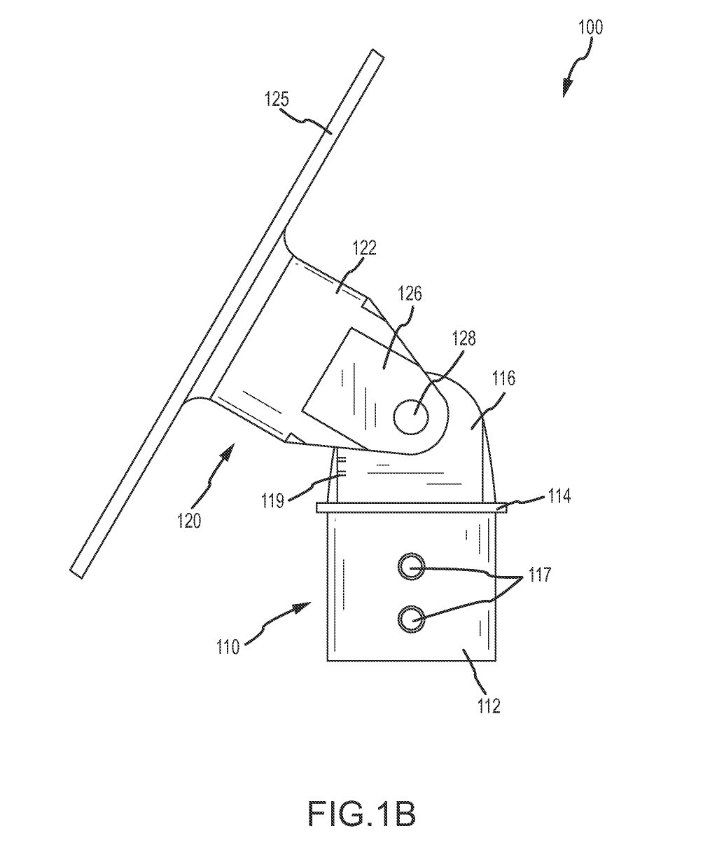

FIGS. 1A and 1B depict an apparatus 100 for attaching an object to a mast according to one embodiment of the invention. More specifically, FIG. 1A provides a perspective view of the apparatus, while FIG. 1B depicts a side view of the same. As referenced in the description below, a mast may be any linearly-fashioned structure to which an object may be attached. While longitudinal axes of most poles are considered to be oriented vertically, masts or similar structures that may be oriented horizontally or in other directions may be employed in further implementations of the invention. Also, the mast may be made of any suitable material, including, but not limited to, steel, aluminum, wood, plastic, fiberglass, and various composite materials. Further, while most masts are cylindrical in cross-section, others cross-sectional shapes, such as square or rectangular, may also be employed in conjunction with the embodiments discussed below.

As discussed in the particular embodiments presented below, the masts are hollow to allow a portion of the apparatus 100 to be inserted therein, although other embodiments are not restricted in such a manner. For example, other versions of the apparatus 100 may be configured to attach to an outside surface of a mast, thus eliminating any requirement for a hollow mast.

As shown in FIGS. 1A and 1B, the connection apparatus or mechanism 100 includes a mast-end component 110 and an object-end component 120. In one example, the mast-end component 110 and the object-end component 120, as well as similar components discussed hereinafter, are manufactured from steel, or from some other metal or alloy, to maximize the strength and rigidity of the apparatus 100. In other examples, a lighter-weight material, such as plastic or fiberglass, may be employed for less demanding or less critical applications.

In this particular implementation, the object-end component 120 is intended to be attached to a satellite television antenna, such as a small dish antenna used in direct-to-home satellite television broadcasting systems. In other implementations, however, the object-end connection 120 may be fashioned to be attached to any object or device of interest.

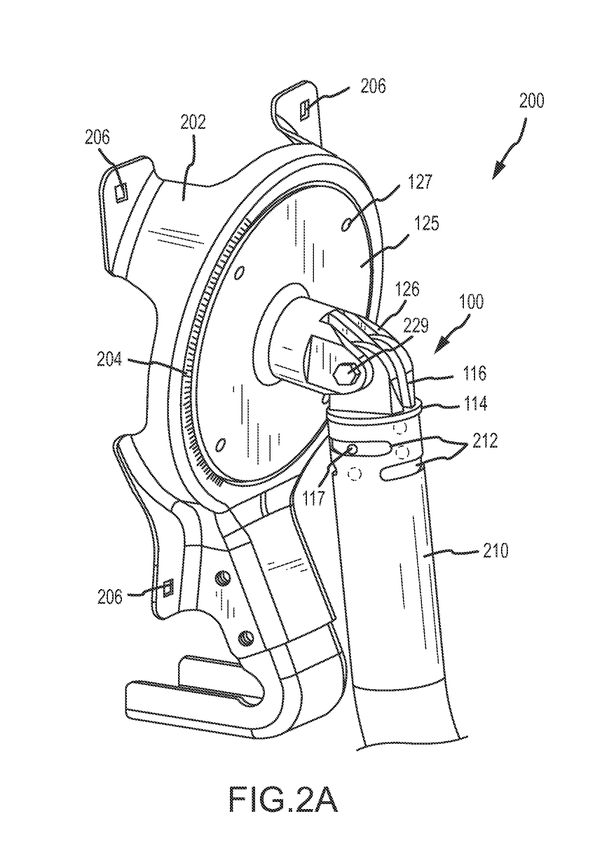

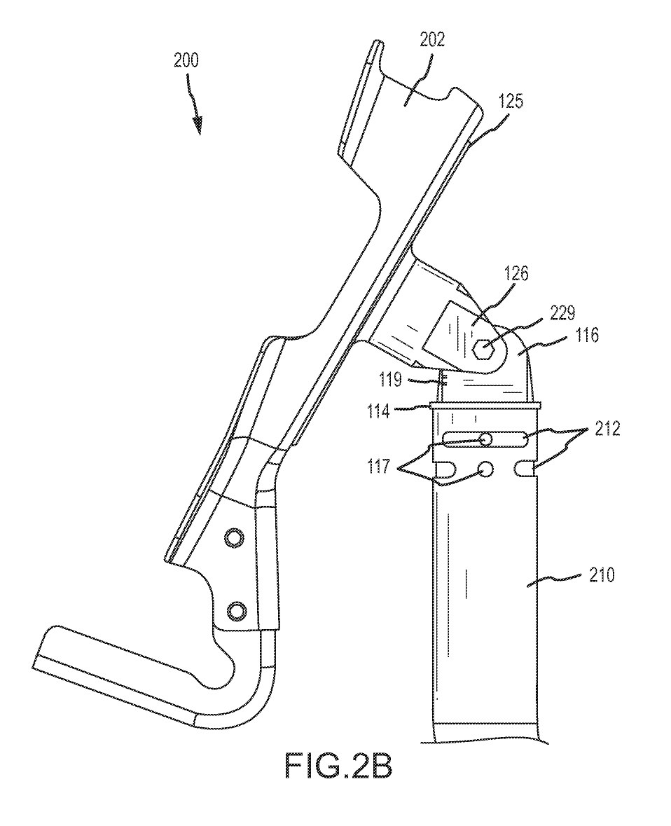

The mast-end component 110 of the apparatus 100 generally includes a first connection region and a first pivot region. In the specific example of FIGS. 1A and 1B, the first connection region includes a cylindrical mating region 112 and a contact region 114, while the first pivot region includes a number of extensions 116 extending from the contact region 114, which is located between the mating region 112 and the extensions 116. The mating region 112 defines threaded holes 117 which facilitate connection of the mast-end component 110 with a mast. The contact region 114 provides a surface against which the end of the mast registers. More details concerning the mating region 112 and the contact region 114 are given below with respect to FIGS. 2A and 2B.

In other examples, such as masts which are not cylindrical in cross-section, the mating region 112 of the apparatus 100 may be of some other shape, such as rectangular, hexagonal, and the like, to mate or couple with a mast of a corresponding form.

Each of the extensions 116 of the mast-end component 110 includes a hole (not in view in FIG. 1A), such as the hole 128 of the object-end component 120. Collectively, holes 128 defined by the extensions 116 are aligned along a single axis 130 perpendicular to the extensions 116. The holes 128 are configured to receive a bolt or other fastener extending along the axis 130 through the extensions 116 to couple the mast-end component 110 with the object-end component 120.

Similar to the mast-end component 110, the object-end component 120 includes a second connection region and a second pivot region, with the second pivot region including a second set of extensions 126 extending from the second connection region. The second extensions 126 are configured to mesh or interleave with the first extensions 116 of the mast-end component 110, as shown in FIG. 1A. In one implementation, each of the sides of each of the first extensions 116 is designed to make contact (or nearly so) with a side of an adjacent second extension 126. In the specific example of FIG. 1A, two first extensions 116 and three second extensions 126 are employed in the apparatus 100, although more or fewer extensions 116, 126 may be employed in other implementations.

Further, like the first extensions 116, each of the second extensions 126 defines a hole 128. As a group, the holes 128 are configured to align along the axis 130 along with the holes 128 of the first extension 116 when the first extensions 116 and the second extensions 126 are properly meshed, as shown in FIG. 1A. In one example, a bolt may then be inserted into a channel formed by the holes 128 of the first extensions 116 and the second extensions 126, and nut attached thereto to couple the mast-end component 110 and the object-end component 120 together. The bolt and nut are not shown in FIGS. 1A and 1B to depict the other components 110, 120 more clearly.

The mast-end component 110 and the object-end component 120 may take any of a number of angular orientations relative to each other about the axis 130. To maintain or “lock in” a particular orientation, the bolt and nut described above, or another type of fastener, may be tightened to compress the extensions 116, 126 together tightly enough to restrict or prohibit relative movement of the components 110, 120.

To enhance the ability of the fastener to maintain the relative angular orientation of the components 110, 120, the sides of the extensions 116, 126 may possess a roughened surface, such as what may be expected from cast steel components. In another example, the sides of the extensions 116 contacting each other may include specific interlocking features, such as ridges or teeth, to further enhance the friction between the first extensions 116 and the second extensions 126 when the fastener is tightened.

As mentioned earlier, the second connection region of the object-end component 120, as shown in FIG. 1A, is adapted to be coupled with a dish antenna by way of an antenna bracket. To facilitate such a connection, the second connection region includes a cylindrical portion 122 coupling the second extensions 126 with an interfacing plate 125 defining holes 127 for attaching the interfacing plate 125 with the antenna bracket. In other embodiments, the second connection region may be fashioned to attach to other objects other than an antenna bracket.

FIGS. 2A and 2B illustrate a subassembly 200 including the apparatus 100 of FIGS. 1A and 1B connected to a mast 210 and an antenna bracket 202. As shown, the mast 210 is oriented vertically to allow effective gross adjustment of the elevation, azimuth, and skew orientation of an antenna dish (not shown in FIGS. 2A and 2B) to be coupled to the antenna bracket 202. However, other implementations involving antennae or various other devices may employ other orientations for the mast 210.

The mast 210 is hollow to accept the cylindrical mating region 112, and defines a number of slots 212 that are configured to align with the holes 117 of the mating region 112 of the apparatus 100 when the mating region 112 is inserted into the end of the mast 210 until the end of the mast 210 makes contact with the contact region 114.

Once the mating region 112 is inserted fully into the mast 210, the apparatus 100 may be rotated until a desired angular orientation between the apparatus 100 and the mast 210 is achieved. At that point, the orientation may be fixed by securely affixing the mating region 112 to the mast 210. In the case of FIGS. 2A and 2B, a bolt (not shown in the figures) is threaded into each threaded hole 117 exposed through a slot 212 of the mast 210, thus affixing the apparatus 100 to the mast 210. In the specific example of FIGS. 2A and 2B, the mast 210 employs four slots 212 in two rows, while the mating region 112 defines four threaded holes 117, also in two rows, with two holes 117 on each side of the mating region 112. With the particular arrangement shown in FIGS. 2A and 2B, at least two of the holes 117, one per each side of the mating region 112, are visible through a slot 212 regardless of the orientation of the mating region 112 compared to the mast 210, thus allowing the mating region 112 to be bolted securely to the mast 210 with at least two bolts at any particular azimuth. In some implementations, either or both of the contact region 114 and the mast 210 may employ alignment marks (not shown in FIGS. 2A and 2B) to aid in determining a desired azimuth for the apparatus 100 relative to the mast 210.

In another implementation, the slots 212 may instead be circular holes that allow only one or a few discrete orientations between the mating region 112 and the mast 210, thus reducing the number of degrees of freedom of adjustment therebetween while possibly adding stability or rigidity to the subassembly 200.

To adjust the elevation of the interfacing plate 125 of the apparatus 100, and thus of the antenna to be coupled thereto, a bolt 229 and corresponding nut may be used to compress the extensions 116, 126 of the connection mechanism 100 enough to maintain a particular angular orientation between the two pivot regions of the apparatus 100 while allowing some movement therebetween for adjustment purposes. Once the desired orientation between the pivot regions, or between the antenna bracket 202 and the mast 210, is achieved, the nut and bolt 229 may be tightened further to secure the connection apparatus 100 at the desired orientation.

To aid in setting the initial orientation between the antenna bracket 202 and the mast 210, an edge of one of the second extensions 126 may be aligned with one of a set of alignment marks 119 located on an adjacent one of the first extensions 116 to determine a desired elevation for the antenna bracket 202. In another example, one of the second extensions 126 may include alignment marks to be compared with an edge or other feature of one of the first extensions 116.

The antenna bracket 202 may be attached to the interfacing plate 125 by way of bolts and nuts (not depicted in FIGS. 2A and 2B) through holes 127 of the interfacing plate 125 and similar features of the antenna bracket 202. In one example, the bracket 202 includes one or more semicircular slots (not visible in FIGS. 2A and 2B) to allow the bracket 202 to be skewed rotationally from vertical. In one embodiment, the antenna bracket 202 defines a plurality of alignment marks 204 for gross skew (rotational) alignment of the bracket 202 relative to vertical. Either or both of the bracket 202 and the interfacing plate 125 may possess such marks for alignment purposes, depending on the particular implementation employed.

The bracket 202 may be attached to a dish antenna by way of one or more holes or openings 206 to facilitate attachment of the antenna to the bracket 202 by way of screws, bolts, nuts, and the like. Thereafter, fine adjustment of azimuth, elevation, and skew may be performing using measurement of the signals being received at the antenna from the desired orbiting satellite. In one example, the antenna is oriented at the point at which the received signals are at their maximum or peak amplitude.

Although the discussion of the attachment of the various portions of the subassembly 200 of FIGS. 2A and 2B is presented in the order from the mast 210 to the connection mechanism 100 to the bracket 202, other orders of the components described above for attachment, adjustment, and the like may be utilized in other examples. In one implementation, all of the components may be attached together, after which the adjustment of the azimuth, elevation, and skew may be undertaken.

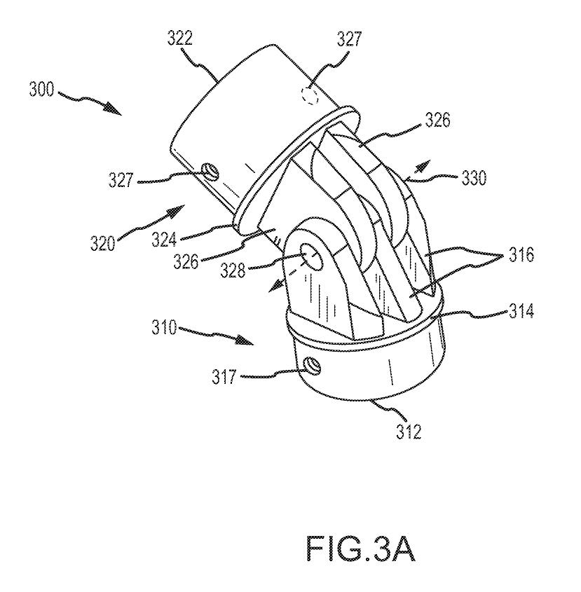

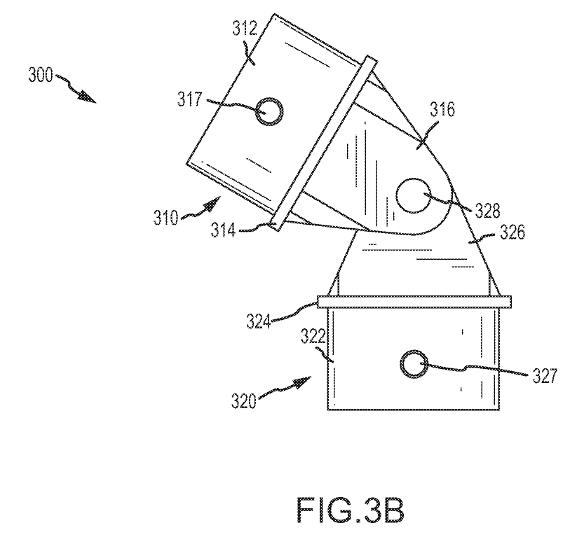

An example of a connection mechanism 300 according to another embodiment of the invention is illustrated in FIGS. 3A and 3B. This particular apparatus 200 is adapted to connect together two masts, such as the mast 210 of FIGS. 2A and 2B. The mechanism 300 includes a first mast-end component 310 and a second mast-end component 320. The first mast-end component 310 includes a first cylindrical mating region 312 defining threaded holes 317, a first contact region 314, and a first set of extensions 316, similar to the mast-end component 110 of FIGS. 1A and 1B.

Coupled with the first mast-end component 310 is the second mast-end component 320, which includes a second cylindrical mating region 322 defining holes 327. The second mast-end component 320 also includes a second contact region 324 and second extensions 326. The second extensions 326 are configured to mesh with the first extensions 316. Also, as is the case with the mechanism 100 of FIGS. 1A and 1B, each of the extensions 316, 326 defines a hole 328 such that the holes 328 are aligned along an axis 330 perpendicular to the extensions 316, 326, thus allowing a bolt to pass therethrough. A corresponding nut may be coupled to the bolt and tightened to compress the extensions 316, 326 together to maintain an angular orientation of the two components 310, 320 with respect to each other in a secure manner. Also, as discussed in greater detail above, the sides of the extensions 316, 326 that contact each other may possess a roughened texture, or may include teeth, ridges, or other protrusive features to increase the friction between adjacent extensions 316, 326.

Further, the number of second extensions 326 may be greater than or equal to the number of first extensions 316 in some arrangements. In FIGS. 3A and 3B, three first extensions 316 and two second extensions 326 are shown. In other examples, however, other numbers of extensions 316, 326 for both the first mast-end component 310 and the second mast-end component 320.

In the particular example of the mechanism 300 of FIGS. 3A and 3B, each of the first mating region 312 and the second mating region 322 includes only two threaded holes 317, 327, unlike the four holes 117 located in the mating region 112 of the apparatus 100. However, other embodiments of the apparatus 300 may include more or less than two holes for each of the mating regions 312, 322. Also, as is the case with the apparatus of FIGS. 1A and 1B, while the mating regions 312, 322 are cylindrical to mate with hollow masts of a similar shape, other shapes may be employed to couple with masts of varying forms and sizes.

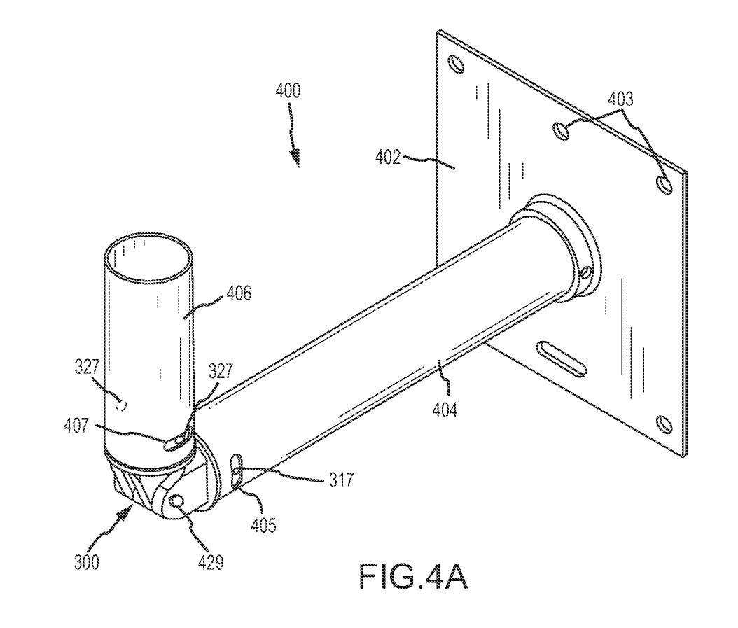

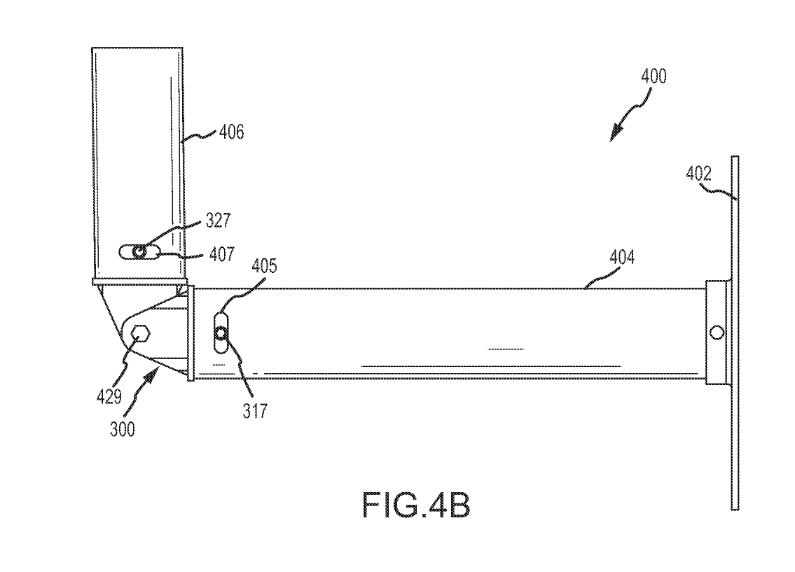

FIGS. 4A and 4B illustrate a subassembly 400 including the apparatus 300 of FIGS. 3A and 3B for connecting a first mast 404 to a second mast 406. In the specific arrangement, one end of the first mast 404 is welded, bolted, or otherwise connected to a support plate 402 having multiple holes 403 for screwing, bolting, or otherwise affixing the plate 402 to a stable surface or structure, such as an exterior wall of a house or other building. While the support plate 402 is depicted as lying within a vertical plane, other orientations for the support plate 402 are possible, thus allowing the support plate 402 to be attached to a roof or other angled surface.

As depicted in FIGS. 4A and 4B, the other end of the first mast 404 is coupled to the first mast-end component 310. More specifically, the first mast 404 defines one or more slots 405 which align with one or more of the holes 317 of the first mating region 312 when the first mating region 312 is inserted into the end of the first mast 404 so that the first contact region 314 makes contacts with the end of the first mast 404. The slots 405 allow some freedom of adjustment in rotational orientation between the first mast 404 and the connection apparatus 300. Once a desired orientation is achieved, the relative position between the first mast 404 and the first mast-end component 310 may be secured by inserting bolts or other fasteners into the threaded holes 317, and tightening them sufficiently.

Correspondingly, the second mast 406 is affixed to the connection mechanism 300. More specifically, the second mast 406 is slid onto the second mating region 322 until the end of the second mast 406 makes contact with the second contact region 324, thus allowing at least one of the holes 327 to be accessed through a slot 407. A bolt or other fastener may then be inserted into each of the holes 327 through the one or more slots 407 and tightened.

In another example, the slots 405, 407 may be round holes, thus allowing one or only a few specific orientations between the connection mechanism 300 and the first mast 404 and/or the second mast 406, thereby restricting the number of degrees of freedom of adjustment between the apparatus 300 and the masts 404, 406 and possibly adding rigidity or strength to the subassembly 400 as a result.

To solidify the connection of the first mast 404 and the second mast 406, a fastener 429, such as a bolt-nut combination, extending through the holes 328 of the extensions 316, 326 of the connection mechanism 300 may then be tightened to maintain a desired orientation between the mast-end components 310, 320. As a result, the entire subassembly 400 takes on a rigidity that may be desirable for a number of uses, such as the mounting of a satellite antenna to a stable structure.

In one embodiment, the subassembly 400 is to be adjusted so that the upper end of the second mast 406 is to be vertically-oriented, such as to receive the communication mechanism 100 and antenna bracket 202 of the subassembly 200 of FIGS. 2A and 2B. As a result, the second mast 406 of FIGS. 4A and 4B may serve as the mast 210 of FIGS. 2A and 2B. With the use of an antenna affixed to the antenna bracket 202, television and/or radio programming may then be received from a geosynchronous satellite. To orient the upper end of the second mast 406 vertically, the axis 328 defined by the connection mechanism 300 would be oriented horizontally by a proper orientation of the first mating region 312 within the end of the first mast 404 to ensure the upper end of the second mast 406 lies in a vertical plane. In addition, the orientation of the two mast-end components 310, 320 about the axis 328 may be set such that the upper end of the second mast 406 is oriented vertically. Such an orientation may then allow adjustment of the azimuth, elevation, and/or skew of the antenna to be set as described more fully above.

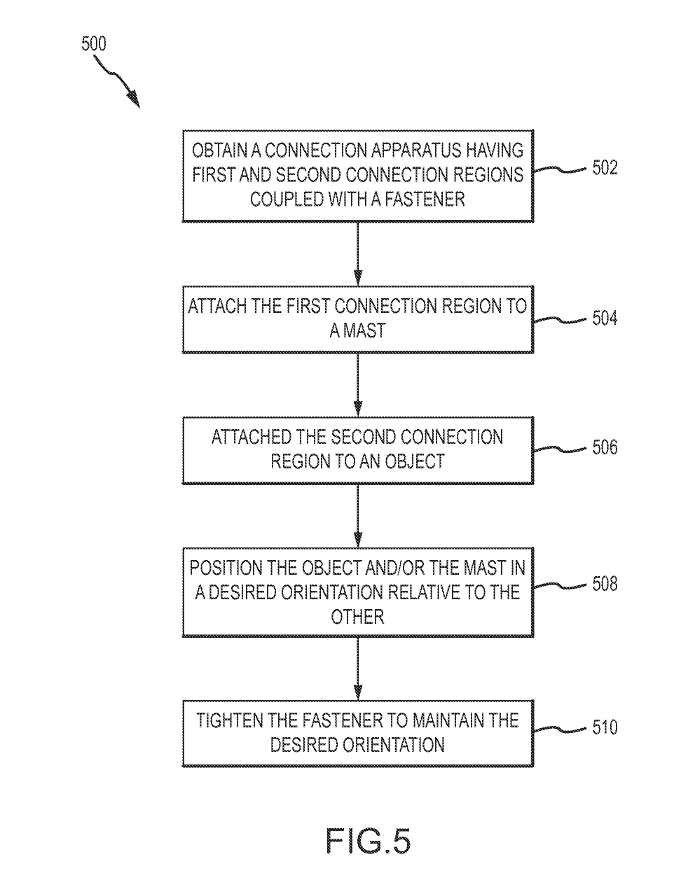

FIG. 5 provides a flow diagram of a general method 500 of attaching an object to a mast, based on the above embodiments. First, a connection apparatus or mechanism, such as the mechanisms 100 and 300 described earlier, is obtained (operation 502). The mechanism has a first connection region and a second connection region coupled together via a fastener. The first connection region is attached to the mast (operation 504), and the second connection region is attached to the object (operation 506). As shown above, the object may be an antenna bracket, another mast, or some other object to be connected to the first mast. The object and/or the mast are then positioned in a desired orientation relative to each other (operation 508). The fastener is then tightened to maintain the desired orientation (operation 510).

While the method 500 is depicted in FIG. 5 as being performed in a single specific order, the operations of the method 500 may be performed in other orders while remaining with the scope of the invention. In one example, attachment of the second connection region to the object (operation 506) may occur before attachment of the first connection region to the mast (operation 504). Other orders of execution may also be possible.

Various embodiments as described herein may provide a number of benefits. Generally, the connection mechanisms and methods disclosed above provide a strong, yet relatively lightweight, device for connection of an object to a mast so that the object maintains its position and orientation in the presence of a number of environmental conditions, such as gravity and high winds. The use of a mating region in some embodiments to insert into the end of a hollow mast further facilitates fine adjustment of the orientation of the object in one direction, such as an azimuth or elevation of the object, without undue “sagging” or maladjustment of the orientation of the object in another direction. In the embodiment of FIGS. 4A and 4B, use of a connection mechanism to connect one mast with another allows the connection mechanism to be located in a position other than at the mounting structure, such as a wall or other surface, which is generally the point of maximum torque for mounting assemblies, such as those utilized for satellite dish antennas. As a result, such a connection mechanism may reduce or eliminate the need for additional struts to fortify an antenna installation while maintaining sufficient clearance between the antenna and the mounting structure.

While several embodiments of the invention have been discussed herein, other embodiments encompassed by the scope of the invention are possible. For example, while various embodiments have been described primarily within the context of satellite and terrestrial antenna systems and similar equipment, any object requiring a stable platform, including signage, lighting, and so on, may benefit from the implementation of the principles described herein, with respect to both outdoor and indoor applications. More specifically, those devices which are often mounted to a wall, stand, or other structure and intended to be set at a desired orientation, such as television flat-panel displays or computer monitors, may be displayed using connection mechanisms as described herein. In addition, aspects of one embodiment disclosed herein may be combined with those of alternative embodiments to create further implementations of the present invention. Thus, while the present invention has been described in the context of specific embodiments, such descriptions are provided for illustration and not limitation. Accordingly, the proper scope of the present invention is delimited only by the following claims and their equivalents.

What is claimed is:

1. An apparatus for mounting an object to a mast, comprising:
a mast-end component comprising a first connection region and a first pivot region, wherein the first connection region is configured to connect with an end of the mast, wherein the first pivot region comprises a first plurality of extensions extending from the first connection region, wherein each of the first plurality of extensions defines at least one opening, and wherein the openings of the first plurality of extensions are aligned along an axis perpendicular to the first plurality of extensions;
an object-end component comprising a second connection region and a second pivot region, wherein the second connection region is configured to connect with the object, wherein the second pivot region comprises a second plurality of extensions extending from the second connection region and meshing with the plurality of extensions of the first pivot region, wherein each of the second plurality of extensions defines at least one opening, and wherein the openings of the second plurality of extensions are aligned with the axis; and
a fastener extending through the openings of the first and second extensions along the axis;
wherein the fastener, when tightened, causes the first and second plurality of extensions to compress together to maintain an angular orientation between the mast-end component and the object-end component about the axis.

2. The apparatus of claim 1, wherein:
the first connection region comprises a mating region and a contact region, wherein the contact region is positioned between the mating region and the first pivot region, and wherein the mating region is configured to connect with an end of the mast so that the contact region makes contact with the end of the mast.

3. The apparatus of claim 2, wherein the mating region defines at least one opening configured to receive a second fastener to affix the mating region to the mast.

4. The apparatus of claim 3, wherein the mating region is cylindrical for fitting within and contacting the inside of the mast to allow the mast-end component to be affixed to the mast in a second angular orientation relative to the mast.

5. The apparatus of claim 4, wherein the contact region defines an alignment mark for indicating the second angular orientation.

6. The apparatus of claim 1, wherein the fastener comprises a bolt and a nut threaded thereon.

7. The apparatus of claim 1, wherein each of the first and second plurality of extensions comprises at least one surface configured to contact a corresponding surface an adjacent one of the first and second plurality of extensions to resist angular movement between the mast-end component and the object-end component when the first and second plurality of extensions are compressed together.

8. The apparatus of claim 7, wherein the surface of each of the first and second plurality of extensions comprises protrusions configured to mate with protrusions of the corresponding surface of the adjacent one of the first and second plurality of extensions.

9. The apparatus of claim 1, wherein at least one of the first pivot region and the second pivot region defines an alignment mark for indicating the angular orientation.

10. The apparatus of claim 1, wherein one of the first and second pivot regions comprises at least two of the extensions, and wherein another of the first and second pivot regions comprises at least three of the extensions.

11. The apparatus of claim 1, wherein the object comprises a second mast, wherein the second connection region comprises a second mating region and a second contact region positioned between the second mating region and the second pivot region, wherein the second mating region is configured to connect with an end of the second mast so that the second contact region makes contact with the end of the second mast.

12. A method for attaching an object to a mast, the method comprising:
obtaining a connection mechanism comprising:
a mast-end component comprising a first connection region and a first pivot region, wherein the first connection region is configured to connect with an end of the mast, wherein the first pivot region comprises a first plurality of extensions extending from the first connection region, wherein each of the first plurality of extensions defines at least one opening, and wherein the openings of the first plurality of extensions are aligned along an axis perpendicular to the first plurality of extensions;
an object-end component comprising a second connection region and a second pivot region, wherein the second connection region is configured to connect with the object, wherein the second pivot region comprises a second plurality of extensions extending from the second connection region and interleaving with the plurality of extensions of the first pivot region, wherein each of the second plurality of extensions defines at least one opening, and wherein the openings of the second plurality of extensions are aligned with the axis; and
a fastener extending through the openings of the first and second extensions along the axis;
attaching the first connection region of the connection mechanism to the end of the mast;
attaching the second connection region of the connection mechanism to the object;
positioning the object in a desired orientation relative to the mast; and
tightening the fastener to compress the first and second plurality of extensions together to maintain the desired orientation.

13. The method of claim 12, wherein:
the first connection region comprises a mating region and a contact region, wherein the contact region is positioned between the mating region and the first pivot region, and wherein the mating region is configured to connect with an end of the mast so that the contact region makes contact with the end of the mast; and
attaching the mating region of the connection mechanism to the end of the mast comprises:
inserting the mating region into the end of the mast until the contact region makes contact with the end of the mast; and
affixing the mating region to the mast.

14. The method of claim 12, wherein the object comprises an antenna.

15. The method of claim 14, wherein attaching the second connection region of the connection mechanism to the antenna comprises:
affixing an antenna bracket to the attachment region; and
affixing the antenna to the antenna bracket.

16. A method for attaching a first mast to a second mast, the method comprising:
obtaining a connection mechanism comprising:
a first mast-end component comprising a first connection region and a first pivot region, wherein the first connection region is configured to connect with an end of the first mast, wherein the first pivot region comprises a first plurality of extensions extending from the first connection region, wherein each of the first plurality of extensions defines at least one opening, and wherein the openings of the first plurality of extensions are aligned along an axis perpendicular to the first plurality of extensions;
a second mast-end component comprising a second connection region and a second pivot region, wherein the second connection region is configured to connect with an end of the second mast, wherein the second pivot region comprises a second plurality of extensions extending from the second connection region and interleaving with the plurality of extensions of the first pivot region, wherein each of the second plurality of extensions defines at least one opening, and wherein the openings of the second plurality of extensions are aligned with the axis; and
a fastener extending through the openings of the first and second extensions along the axis;
attaching the first connection region of the connection mechanism to the end of the first mast;
attaching the second connection region of the connection mechanism to the end of the second mast;
positioning the first mast and the second mast in a desired orientation relative to each other; and
tightening the fastener to compress the first and second plurality of extensions together to maintain the desired orientation.

17. The method of claim 16, wherein one of the first mast and the second mast is oriented in a vertical plane in the desired orientation.

18. The method of claim 16, wherein a second end of one of the first mast and the second mast is coupled with an antenna.

19. The method of claim 16, wherein:
the first connection region comprises a first mating region and a first contact region, wherein the first contact region is positioned between the first mating region and the first pivot region, and wherein the first mating region is configured to connect with an end of the first mast so that the first contact region makes contact with the end of the first mast; and
the second connection region comprises a second mating region and a second contact region, wherein the second contact region is positioned between the second mating region and the second pivot region, and wherein the second mating region is configured to connect with an end of the second mast so that the second contact region makes contact with the end of the second mast.

20. The method of claim 19, wherein:
attaching the first connection region of the connection mechanism to the end of the first mast comprises inserting the first mating region into the end of the first mast and affixing the first mating region to the end of the first mast; and
attaching the second connection region of the connection mechanism to the end of the second mast comprises inserting the second mating region into the end of the second mast and affixing the second mating region to the end of the second mast.
